(19) United States
(12) Patent Application Publication
(10) Pub. No.: US 2005/0078997 A1
(43) Pub. Date: Apr. 14, 2005

(54) Print cartridge support system

(75) Inventors: Jeffrey G. Bingham, Vancouver, WA (US); Lisa M. Hanson, Vancouver, WA (US); Michael K. Bowen, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/682,718

(22) Filed: Oct. 9, 2003

(51) Int. Cl. B41J 29/00

(52) U.S. Cl. 400/679

(57) ABSTRACT

A print cartridge support system for locating a print cartridge in a printer includes a cartridge docking bay and a latch mechanism. The cartridge docking bay is configured to removably receive the print cartridge. The latch mechanism includes a body and a retainer. The body is movably supported relative to the bay for movement between a closed position and an open position. The retainer is movably coupled to the body to move between a retaining position in which the retainer releasably engages the bay when the body is in the closed position and a releasing position.

### BACKGROUND OF THE INVENTION

Inkjet printing systems typically print images upon paper by scanning a carriage carrying one or more print cartridges across the paper as the paper is horizontally moved relative to the carriage. The one or more print cartridges are retained in place by one of various known latch mechanisms. Examples of such latch mechanisms are disclosed in U.S. Pat. No. Re 37,671; U.S. Pat. No. 6,471,334; and U.S. Pat. No. 6,481,829.

Although such conventional inkjet printing systems enable easy replacement of exhausted print cartridges, such systems have relatively large footprints (i.e. the horizontal space required by the printer) during their use. In many home or office environments, this space is not available. As a result, there remains an ongoing need for a more space efficient printer and associated printer subsystems that facilitate such space efficiency.

### BRIEF DESCRIPTION OF THE DRAWINGS

FIG. 1 is a top plan view schematically illustrating one example of a printing system of the present invention.

FIG. 2 is a top perspective view of one specific embodiment of the printing system of FIG. 1.

FIG. 3 is a top perspective view of a print cartridge support system of the printing system of FIG. 2 loaded with a print cartridge.

FIG. 4 is an exploded perspective view of the print cartridge support system and print cartridge of FIG. 3.

FIG. 5 is an exploded front perspective view of a latch mechanism of the print cartridge support system of FIG. 4.

FIG. 6 is an exploded rear perspective view of the latch mechanism of FIG. 5.

FIG. 7 is a rear perspective view of the print cartridge support system of FIG. 3 with portions omitted for purposes of illustration and with the latch mechanism in a loading position.

FIG. 8 illustrates the print cartridge support system and print cartridge of FIG. 7 with the print cartridge removed and with the latch mechanism in a loaded position.

FIG. 9 is a sectional view of the print cartridge support system and print cartridge of FIG. 7 taken along line 9-9.

FIG. 10 is an enlarged view of the print cartridge support system and print cartridge of FIG. 9 taken along line 10-10.

### DETAILED DESCRIPTION OF THE EXAMPLE EMBODIMENTS

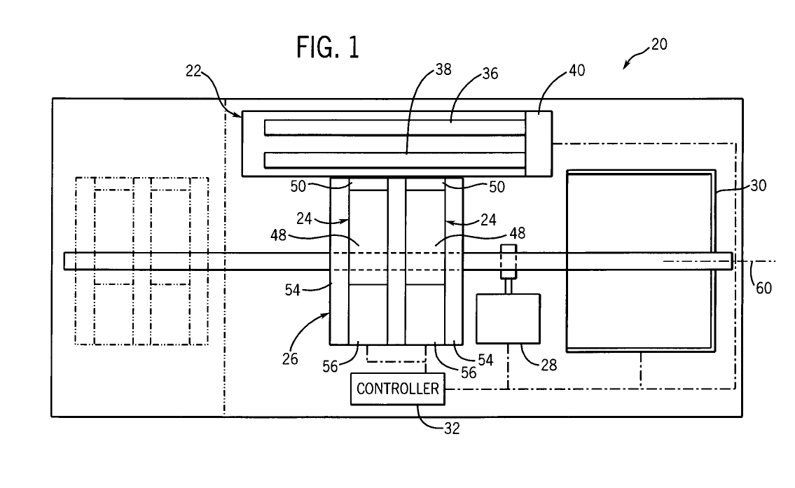

FIG. 1 is a top plan view schematically illustrating printing system 20, an example of one embodiment of the present invention. Printing system 20 generally includes media supply 22, print cartridges 24, print cartridge support system 26, drive system 28, service station 30 and controller 32. Media supply 22 delivers a print medium adjacent to one or more print cartridges 24. In particular, media supply 22 delivers and supports a print medium in a non-horizontal orientation relative to print cartridges 24 as print cartridges 26 deposit ink upon the print medium. Media supply 22 includes a media input 36, a media output 38 and a media transport system 40. Media input 36 generally comprises an opening through which print medium is loaded into printing system 20. Media input 36 may be configured to temporarily store print media for use in printing system 20. In one particular embodiment, media input 36 may comprise a tray configured to receive a stack of print media, wherein the tray itself is removably inserted into printer 20.

Media output 38 comprises an opening through which printed upon medium is ejected or removed from system 20. Input 36 and output 38 each extend along a single perimeter plane of printing system 20. In the particular embodiment illustrated, input 36 and output 38 both extend along a top surface of printing system 20. In alternative embodiments, input 36 and output 38 may be located along a corner of system 20, wherein one of input 36 and output 38 extends along a top plane adjacent the corner and wherein the other of input 36 and output 38 extends along a side plane of system 20 adjacent the corner. Input 36 is generally configured to support the print medium being input into system 20 in a non-horizontal plane. Output 38 is also configured to support the print medium being output from system 20 in a non-horizontal plane. In the particular embodiment illustrated, input 36 supports the print medium in a vertical plane (i.e. 90 degrees from horizontal) while output 38 supports the print medium in a non-horizontal plane no greater than 22.5 degrees below vertical. To further reduce the overall horizontal area or footprint required by media supply 22, output 38 is configured to support the print medium being ejected from system 20 in a non-horizontal plane no greater than 15 degrees from vertical. In the particular embodiment illustrated, output 38 is configured to support the print medium in a non-horizontal plane of about 5 degrees below vertical towards front 44 of system 20. As a result, a control panel for system 20 may also be located along the top surface of system 20, further reducing the footprint of system 20.

In alternative embodiments, the angular offset between input 36 and output 38 may be reversed such that output 38 is configured to support the print medium in a vertical plane while input 36 loads or supports the print medium in a non-horizontal plane offset from the vertical. In still other embodiments, both input 36 and output 38 may be configured to load, support or eject print medium in planes angularly offset from one another by no greater than 22.5 degrees, and in some embodiments no greater than 15 degrees and nominally no greater than 5 degrees, wherein neither plane is vertical, but is non-horizontal.

Media transport system 40 generally comprises a mechanism configured to move the print medium from input 36 to output 38 as ink from cartridges 24 is deposited upon the medium. In a particular embodiment, system 40 includes a plurality of rotatably driven rollers (not shown) configured to engage print medium loaded in input 36. The rollers move the medium through a U-turn, enabling the medium to be ejected through output 38. After the print medium has undergone the U-turn, ink from cartridges 24 is deposited upon the medium prior to ejection of the medium. In alternative embodiments, system 20 may alternatively be configured such that ink from cartridges 24 is deposited upon the print medium prior to system 40 moving the medium through the U-turn towards output 38. In still other embodiments, drive mechanism 40 may comprise mechanisms other than rollers for moving the medium from input 36 to output 38.

Print cartridges 24 each have an ink reservoir 48 and a nozzle face 50 containing a plurality of nozzles through which ink from reservoir 48 is dispensed or ejected onto a print medium. The exact size, shape or configuration of cartridges 24 may vary depending upon the particular configuration and size of support system 26 and printer system 20.

Print cartridge support system 26 comprises a system configured to removably receive, support and retain one or more print cartridges 24 proximate to the print medium as ink or other printing fluid from cartridges 24 is printed upon the print medium. In particular, support system 26 is configured to support each cartridge 24 in an orientation such that each nozzle face 50 extends in a non-horizontal plane and faces the print medium. For each print cartridge 24 supported by system 26, system 26 includes docking bay 54 and latch mechanism 56. The docking bay 54 may also be referred to in some embodiments as a carriage. Docking bay 54 comprises one or more structures configured to support or receive at least one print cartridge 24 in an orientation such that nozzle face 50 extends in a non-horizontal plane facing the print medium. In one embodiment, docking bay 54 may merely include a floor or a platform upon which one or more print cartridges 24 are positioned. In another embodiment, docking bay 54 may include a floor and sidewalls or only sidewalls which engage the one or more print cartridges 24. Docking bay 54 cooperates with latch mechanism 56 to ensure that print cartridges 24 are properly positioned with respect to the print medium for accurate and precise control of the deposition of ink upon the print medium.

Latch mechanism 56 comprises a mechanism configured to secure print cartridges 24 to or within docking bay 54 to prevent their withdrawal from docking bay 54. In addition, latch mechanism 56 engages one or more print cartridges 24 to apply one or more forces to print cartridges 24 to urge print cartridges 24 towards a predefined position with respect to the print medium. For example, latch mechanism 56 may be configured to urge one or more print cartridges 24 against print cartridges locating surfaces or datums provided on docking bay 54 to ensure that cartridges 24 are properly located on docking bay 54 relative to the print medium. Latch mechanism 56 may urge nozzle face 50 in a substantially horizontal direction towards the print medium. Latch mechanism 56 may additionally or alternatively urge print cartridge 24 in a downward non-horizontal direction towards print datums or towards print cartridge locating surfaces beneath print cartridge 24.

In the particular embodiment illustrated, print cartridge support system 26 is formed as a carriage configured to move along axis 60. Drive system 28 comprises a drive mechanism configured to power the movement of support system 26 along axis 60. Drive system 28 moves support system 26 between a printing range in which support system 26 is scanned across the print medium, a servicing position in which support system 26 is located adjacent to service station 30 and a loading/unloading position (shown in phantom lines), facilitating loading and unloading of print cartridges 24 from support system 26. Although the loading/unloading position is illustrated as being opposite to service station 30, the loading/unloading position may alternatively be over service station 30.

Service station 30 comprises a conventionally known mechanism configured to service one or more print cartridges 24. In particular, service station 30 is configured to perform operations such as wiping, capping and blotting.

Controller 32 comprises a processor unit in communication with media drive 22, print cartridges 24 and support drive system 28. For purposes of the disclosure, the term “processor unit” shall include a processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 32 is not limited to any specific combination of hardware circuitry and software, nor to any particular source for the instructions executed by the processing unit. Controller 32 generates control signals for controlling movement of print medium by media supply 22, movement of support system 26 by drive system 28 and the depositing of ink upon the print medium by print cartridges 24. In alternative embodiments, controller 32 may generate control signals for controlling only a portion of the components of printing system 20.

Overall, printing system 20 provides a compact, space efficient printer. Because media supply 22 has an input 36 and an output 38 that are closely spaced to one another and because input 36 and output 38 both support a print medium in non-horizontal planes, the “in-use” footprint of printing system 20 is the same size as the stowed footprint of printing system 20. This orientation of the print medium is facilitated by print cartridge support system 26 which orients print cartridges 24 such that their nozzle faces also extend in non-horizontal planes facing the print medium.

Although printing system 20 is illustrated as being configured to move print cartridge support system 26 across the print medium during printing, printing system 20 may alternatively be configured such that print cartridge support system 26 is stationarily supported relative to the medium. Although print cartridge support system 26 is illustrated for supporting two print cartridges 24, support system 26 may alternatively be configured for supporting a single print cartridge or greater than two print cartridges. Although such print cartridges 24 are illustrated as having ink reservoirs, print cartridges 24 may alternatively be supplied with ink from off-axis ink reservoirs.

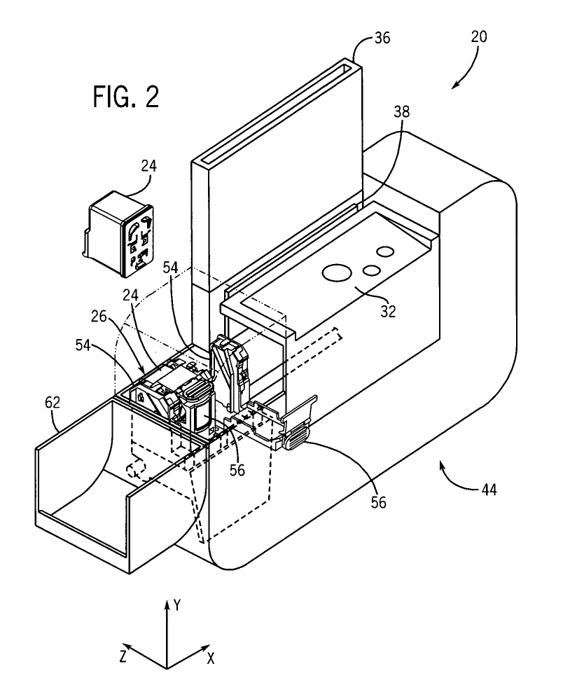

FIG. 2 illustrates one embodiment of printing system 20 in greater detail. FIG. 2 illustrates printing system 20 with cartridge access door 62 pivoted to an open position to expose print cartridge support system 26 in the loading/unloading position. For purposes of illustration, print cartridge support system 26 is illustrated with one of its bays 54 empty and ready for the receipt of a print cartridge 24 and with the other of its bays filled with a print cartridge 24. Once the print cartridges 24 have been positioned within docking bays 54 and once latch mechanisms 56 have been moved from a loading position to a loaded position which secures cartridges 24 in place, a printing operation may begin.

To use system 20, a print medium is loaded through opening 36. After being printed upon by at least one print cartridge 24, the print medium is ejected through output 38. Because both input 36 and output 38 extend along a top surface of system 20, the in-use footprint of printing system 20 is the same size as the stowed footprint, enabling printing system 20 to utilize less desk or shelf space.

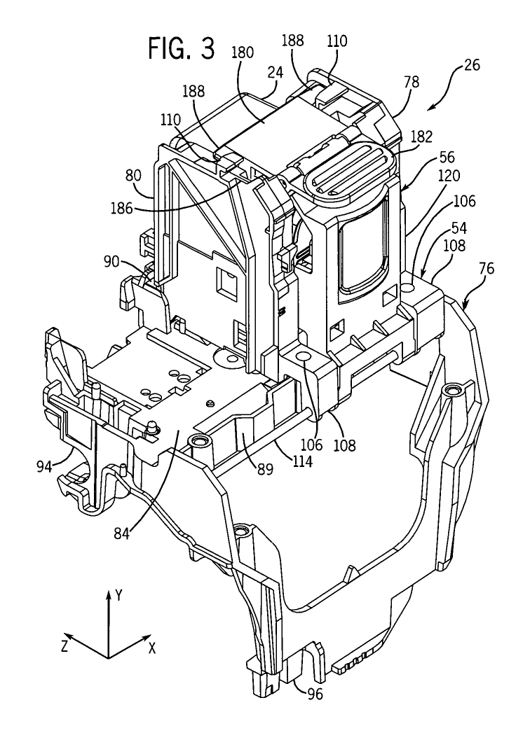

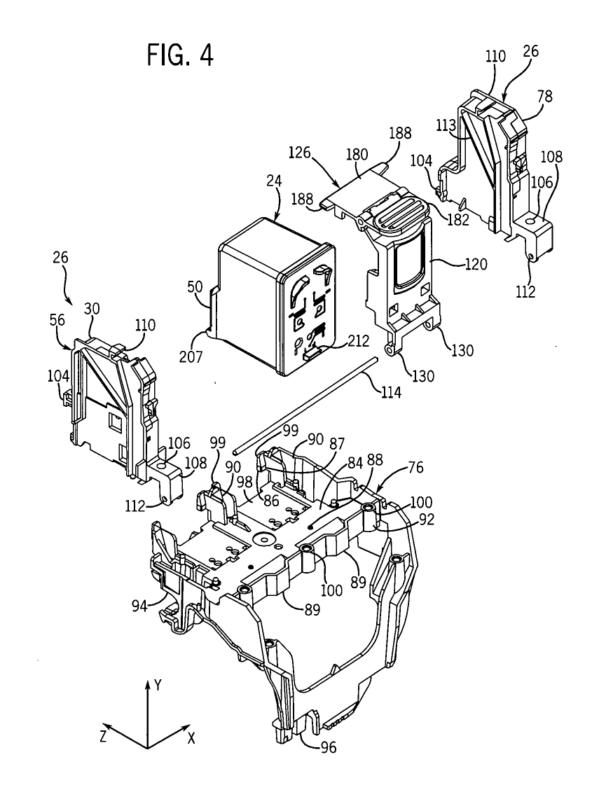

FIGS. 3-10 illustrate print cartridge support system 26 in greater detail. FIGS. 3 and 4 illustrate print cartridge support system 26 in greater detail. FIG. 3 is a top perspective view of support system 26 illustrating a single docking bay 54 with latch mechanism 56 in the loaded position. FIG. 4 is an exploded perspective view of support system 26 and print cartridge 24. As shown by FIG. 4, docking bay 54 includes base 76, sidewall 78 and sidewall 80. Base 76 comprises a structure upon which cartridge 24 rests when inserted into docking bay 54. Base 76 includes floor 84, docking bay datums 86, 87, 88, sidewall mounting structures 90, 92, bearing 94 and bearing 96. Floor 84 extends below a majority of print cartridge 24 when print cartridge 24 is positioned within docking bay 54. Floor 84 includes a recess 98 configured to receive an interconnect strip (not shown) by which controller 32 electrically communicates with print cartridge 24.

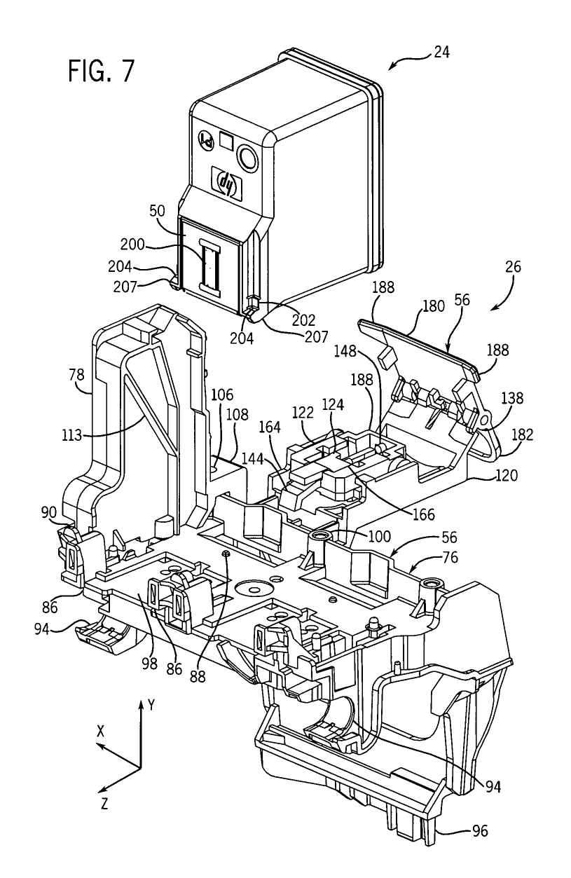

Docking bay datums 86, 87 and 88 constitute reference surfaces for locating print cartridge 24 within docking bay 54 to ensure that print cartridge 24 is properly positioned relative to the print medium. As shown by FIG. 7, datums 86 and 87 comprise surfaces provided by projection 99 extending outward from sidewall mounts 90. Datums 86 extend along an underside of projections 99 while datums 87 extend along a backside of projection 99. Datum 88 generally comprises a projection configured to engage an opposite reference pad of print cartridge 24. Datum 88 projects in the positive Y-axis direction from floor 84. Although base 76 is illustrated as including three such datums for print cartridge 24, base 76 may alternatively include a fewer or greater number of such datums. Moreover, the configuration as well as the location of such datums may vary depending upon the configuration of print cartridge 24, the configuration and location of the datums of print cartridge 24 and the particular requirements for locating print cartridge 24 relative to the print medium.

Latch-engaging portion 89 generally comprises a cavity configured to receive a portion of latch mechanism 56 as latch mechanism 56 is moved from the loading position to the loaded position. Engaging portion 89 ensures that portions of latch mechanism 56 properly bear against print cartridge 24 to position print cartridge 24.

Sidewall mounting portions 90 and 92 facilitate the mounting of sidewalls 78 and 80 to base 76. Sidewall mounting portions 90 project from floor 84 and are configured to receive and interlock with portions of sidewalls 78 and 80. Portions 92 provide bores 100 through which fasteners (not shown) may be used to further secure sidewalls 78 and 80 to base 76. In alternative embodiments, mounting portions 92 may also be configured to mount to sidewalls 78 and 80 without the use of fasteners by using components that snap together.

Bearing 94 extends below floor 84 and is configured to slidably engage a carriage rod (not shown) to facilitate movement of base 76 along the carriage rod. Bearing 96 extends from floor 84 and is configured to engage a guide surface (not shown) to prevent rotation of docking bay 54. As a result, base 76 is movable along the axis of the carriage rod between the printing range, the print cartridge loading/unloading position and the service station 30 described above with respect to FIG. 1. In alternative embodiments, base 76 may omit bearing 94 and bearing 96 in those applications where base 74 is moved relative to the print medium by alternative drive arrangements. In still other embodiments, bearing 94 and bearing 96 may be omitted in those applications where support system 26 does not serve as a carriage but is stationarily supported relative to the print medium as the ink from print cartridge 24 is deposited upon the print medium.

In the particular embodiment illustrated, base 76 is illustrated for providing a continuous floor 84 for two adjacent docking bays 54 (only one of which is shown). In alternative embodiments, base 76 may be configured to provide a floor 84 for a single docking bay 54 or for greater than two docking bays 54 depending upon the number of print cartridges 24 to be supported adjacent to the print medium.

Sidewall 78 and sidewall 80 mount to base 76 to form a chute into which print cartridge 24 is positioned. Sidewall 78 includes mounting tab 104, mounting bore 106, hinge support 108 and catch 110. Mounting tab 104 is inserted into mounting portion 90 of base 76 while hinge support 108 extends around base 76 to align mounting bore 106 with bore 100. Bore 106 and bore 100 facilitate the insertion of a fastener (not shown) which secures sidewall 78 in place. Hinge portion 108 includes a pair of aligned bores 112 which receive and support a portion of pivot shaft 114. Catch 110 comprises a hook-shaped structure configured to be releasably engaged by latch mechanism 56.

Sidewall 80 is substantially identical to sidewall 78 except that sidewall 80 functions as a sidewall for two consecutive docking bays 54. In alternative embodiments, sidewall 80 may be configured to form a sidewall of a single docking bay 54. Like sidewall 78, sidewall 80 includes a hinge support 108 having a pair of aligned bores 112 which receive and support another portion of pivot shaft 114. Unlike sidewall 78, sidewall 80 additionally includes an X-axis bias mechanism, such as a resilient prong or spring, configured to engage and urge cartridge 24 towards side surface 113 of sidewall 78 to position cartridge 24 along the X-axis. Although sidewalls 78 and 80 are illustrated as being removably mounted to base 76, sidewalls 78 and 80 may alternatively be permanently mounted, adhered, welded or fused to base 76. In still other embodiments, one or both of sidewalls 78 and 80 may be integrally formed as part of a single unitary body with base 76. The size, shape and configuration of sidewalls 78 and 80 may vary depending upon the configuration of print cartridge 24 and base 76.

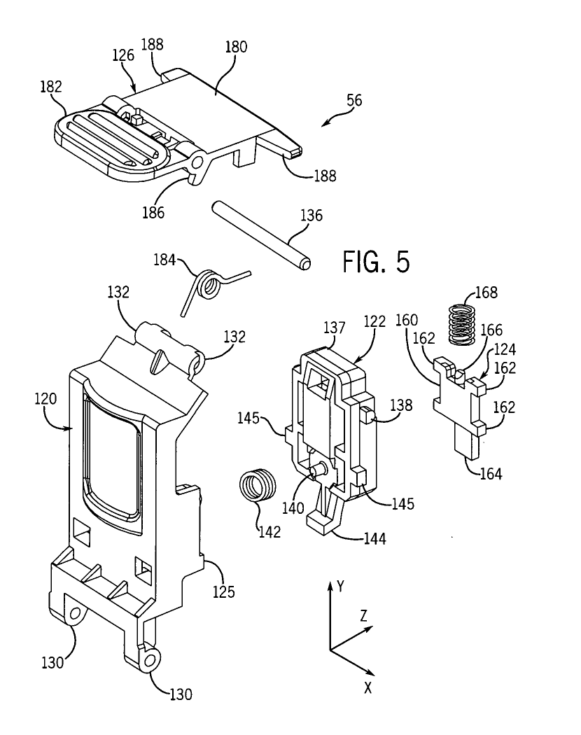

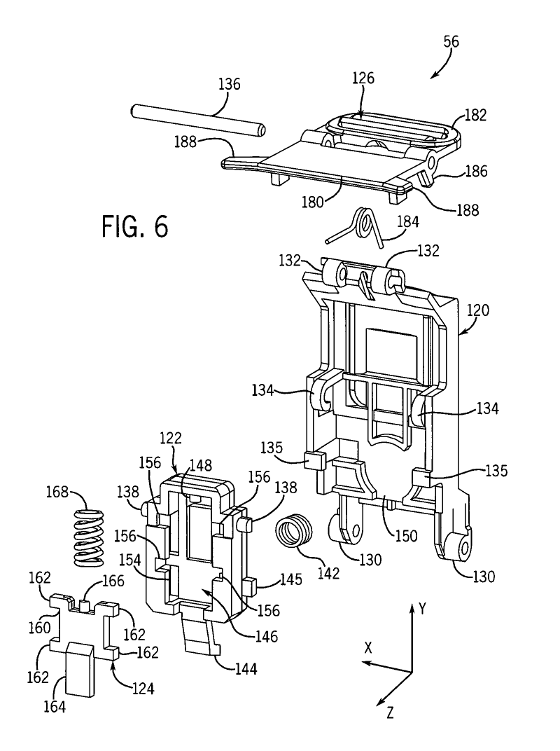

Latch mechanism 56 is movably supported relative to docking bay 54 for movement between the loaded position 70 (shown in FIG. 3) and the loading position 72 (shown in FIG. 7). In the particular embodiment illustrated, latch mechanism is pivotably supported by pivot shaft 114 for pivotal movement between loaded position 70 and loading position 72. As shown by FIGS. 5 and 6, latch mechanism 56 generally includes latch body 120, bias mechanism 122, bias mechanism 124 and retainer 126.

Body 120 is pivotally coupled to docking bay 54 by pivot shaft 114 for pivotal movement between an open position (shown in FIG. 7) and a closed position (shown in FIG. 3). Body 120 supports retainer 126, bias mechanism 122 and bias mechanism 124 and includes docking bay journal boxes 130, retainer journal boxes 132 and bias mechanism supports 134. Docking bay journal boxes 130 comprise a pair of aligned journal boxes which receive pivot shaft 114 to enable body 120 to pivot about the axis of pivot shaft 114. Retainer journal boxes 132 comprise a pair of aligned journal boxes which receive pivot shaft 136 which pivotally supports retainer 126 relative to body 120. Although body 120 is illustrated as being pivotally coupled to docking bay 54 by pivot shaft 114 and journal boxes 130 and pivotally coupled to retainer 126 by journal boxes 132 and pivot shaft 136, latch body 120 may alternatively be pivotally coupled to either docking bay 54 or retainer 126 by other arrangements for pivotally supporting one component relative to another. For example, body 120 may alternatively be pivotally supported relative to docking bay 54 by a living hinge formed between body 120 and docking bay 54.

Bias mechanism supports 134 project from body 120 along the Z-axis and are configured to mount bias mechanism 122 to the remainder of body 120. In addition, in the particular embodiment illustrated, supports 134 movably mount bias mechanism 122 to enable bias mechanism 122 to move along the Z-axis towards print cartridge 24 so as to engage print cartridge 24. In the embodiment illustrated, supports 134 comprise hooks which pivotally receive corresponding projections 138 extending from bias mechanism 122. In alternative embodiments, bias mechanism 122 may be pivotally coupled to body 120 by various other pivotal support structures.

Bias mechanism 122 is movably coupled to body 120 and is configured to apply a force to print cartridge 24 to urge cartridge 24 in a positive Z-axis direction. In addition, bias mechanism 122 movably supports bias mechanism 124. Bias mechanism 122 includes main structure 137, pivot posts or projections 138, spring support 140, spring 142, hook 144, latch body engaging tabs 145, bias mechanism mounting portion 146 and spring support 148. Main structure 137 comprises a structure connecting the remaining components of bias mechanism 124. Projections 138 project outwardly from main structure 137 and are configured to be received within supports 134 to pivotally support main structure 137 relative to latch body 120. As a result, the lower portion of main structure 137 pivots in a direction along the Z-axis about an axis formed by projections 138.

Spring support 140 is coupled to main structure 137 and is configured to support a biasing device, such as a spring, between main structure 137 and latch body 120. In the particular embodiment illustrated, spring support 140 comprises a projection extending in a direction along the Z-axis and configured to engage compression spring 142 to couple spring 142 to structure 137.

Spring 142 comprises a compression spring extending from support 140 into engagement with surface 150 of latch body 120 (shown in FIG. 6). Spring 142 resiliently biases the lower portion of structure 137 in the positive Z-axis direction towards print cartridge 24 when latch body 120 is in the closed position. In alternative embodiments, other biasing devices may be used to resiliently bias at least a portion of structure 137 towards print cartridge 24 when latch body 120 is in the closed position. For example, in lieu of employing a compression spring 142, bias mechanism 124 may alternatively include a leaf spring or other forms of spring mechanisms. In lieu of the spring 142 being coupled to structure 137 by support 140, spring 142 may alternatively be coupled to latch body 120, wherein the spring engages a surface of structure 137.

Docking bay engaging hook 144 extends from main structure 137 and is configured to be received within latch engaging portion 89 of base 76 as latch body 120 is pivoted from the open position to the closed position. Hook 144 engages base 76 to a position structure 137 against print cartridge 24 when latch body 120 is in the closed position.

Latch body engaging tabs 145 project outwardly from main structure 137 and are configured to abut corresponding pads 135 of latch body 120. Tabs 145 abut pads 135 which serve as limit surfaces to limit maximum compression of spring 142 during engagement of structure 137 with print cartridge 24.

Mounting portion 146 releasably and movably couples bias mechanism 124 to structure 137 of bias mechanism 122. In the embodiment illustrated, mounting portion 146 comprises a recess 154 having an insertion opening 156 through which bias mechanism 124 is inserted into recess 154. Recess 154 slidably captures and retains bias mechanism 124 for movement along the Y-axis. In alternative embodiments, mounting portion 146 may have various other configurations for movably supporting bias mechanism 124 along the Y-axis. For example, bias mechanisms 122 and 124 may be movably supported relative to one another by a tongue-and-groove arrangement.

Spring support 148 extends from structure 137 within recess 154. Spring support 148 comprises a projection configured to support the biasing device, such as a spring, between structure 137 and bias mechanism 124.

Bias mechanism 124 is configured to apply a force to print cartridge 24 so as to urge print cartridge 24 in the negative Y-axis direction against datums 86 and 88. In the particular embodiment illustrated, bias mechanism 124 includes a main structure 160, mounting ears 162, pusher 164, spring support 166 and spring 168. Main structure 160 comprises a structure which connects the remaining components of bias mechanism 124. Mounting ears 162 extend outwardly from main structure 160 and are configured to be inserted through openings 156 of bias mechanism 122 to enable bias mechanism 124 to be inserted into recess 154. Once bias mechanism 124 has been inserted into recess 154 of bias mechanism 122, ears 162 are slidably captured within recess 154 for movement in the Y-axis direction.

Pusher 164 comprises a projection extending from main structure 167 and configured to engage print cartridge 24 to urge print cartridge 24 in the negative Y-axis direction. Pusher 124 is resiliently biased towards print cartridge 24 by compression spring 168 which is secured between main structure 160 of bias mechanism 124 and main structure 137 of bias mechanism 122 by spring supports 148 and 166. In alternative embodiments, bias mechanism 124 may utilize other resiliently biasing devices or other springs for biasing pusher 164 in the negative Y-axis direction.

Retainer 126 is movably coupled to latch body 120 for movement between a retaining position in which retainer 126 releasably engages docking bay 54 to releasably retain body 120 in the closed position and a release position enabling body 120 to be moved to the open position. Retainer 126 includes engaging portion 180, button portion 182, spring 184, and limit surfaces 186. Engaging portion 180 is configured to be moved into and out of engagement with catches 110 of docking bay 54. Engaging portion 180 includes catches or wings 188 which hook upon catches 110 when retainer 126 is in the retaining position.

Button portion 182 is coupled to engaging portion 180 so as to pivot engaging portion 180 and wings 188 about pivot shaft 136 into and out of engagement with catches 110. Because button portion 182 is coupled to engagement portion 180 on an opposite side of the axis of pivot shaft 136, button portion 182 functions as a lever. Depressment of button 182 in a downward direction (in the negative Y-axis direction) lifts wings 188 out of engagement with catches 110. Consequently, movement of retainer 126 from the retaining position to the release position to enable latch body 120 to be pivoted to the open position and to enable print cartridge 24 to be withdrawn may be easily achieved by the user pushing upon button portion 182.

Spring 184 resiliently biases engaging portion 180 towards the retaining position in which wings 188 engage catches 110 when body 120 is in the closed position. In the particular embodiment illustrated, spring 184 comprises a torsion spring having a first end secured to retainer 126 and a second end secured to latch body 120. Stop surfaces 186 extend from the remainder of retainer 126 and are configured to abut opposite portions of latch body 120 to limit the rotation of retainer 126 about the axis of pivot shaft 136 due to the bias provided by spring 184.

Although retainer 126 is illustrated as utilizing a torsion spring 184 for resiliently biasing wings 188 towards the retaining position, retainer 126 may alternatively utilize other bias devices or other spring mechanisms for resiliently biasing retainer 126 towards the retaining position. For example, retainer 126 may alternatively utilize a compression spring or leaf spring coupled between body 120 and button portion 182 or a tension spring coupled between body 120 and engagement portion 180.

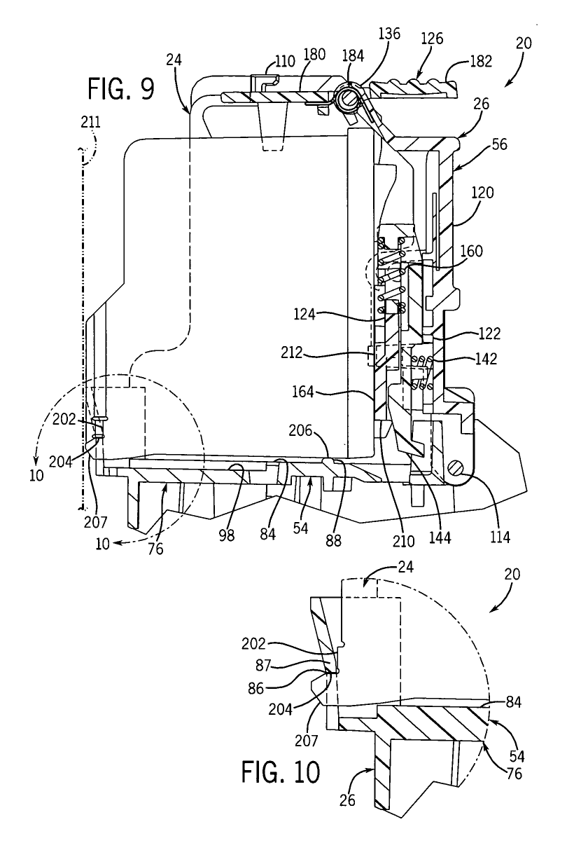

FIGS. 7-10 illustrate the loading of print cartridge 24 into docking bay 54 and the operation of latch mechanism 56. As shown by FIG. 7, print cartridge 24 includes a nozzle face 50 which includes a nozzle plate 200 providing a plurality of nozzles through which ink is dispensed. Print cartridge 24 additionally includes print cartridge datums 202, 204 and 206 (shown in FIG. 9). Datums 200 and 204 are generally provided by a pair of hooks 207 formed on opposite sides of nozzle face 50. Datums 202 generally comprise reference surfaces located along the back of hooks 206 and are configured to abut datums 87 of docking bay 54 when cartridge 24 is loaded. Datums 204 are generally formed on the top of hooks 207 and are configured to abut datums 87 of docking bay 54 when print cartridge is loaded into docking bay 54. Datum 206 (shown in FIG. 9) generally comprises a pad which abuts datum 88 of docking bay 54. Such pairs of datums interact with one another to ensure that print cartridge 24 is in the proper orientation to the print medium 211 being printed upon.

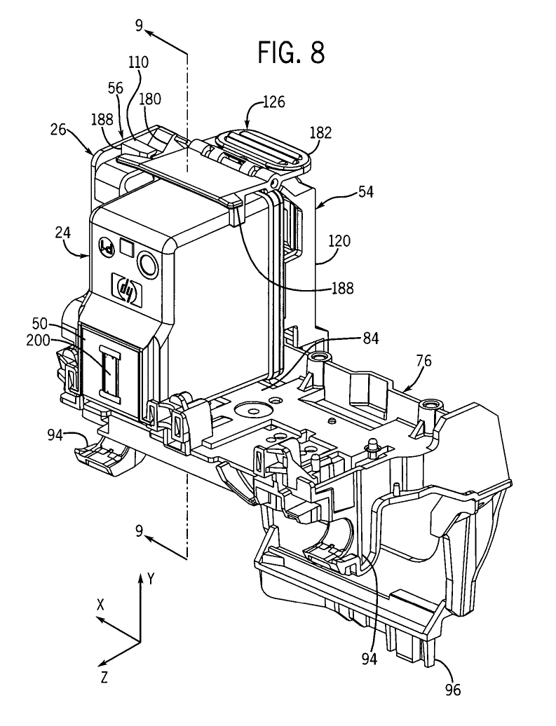

Once print cartridge 24 has been lowered between sidewalls 78 and 80 (shown in FIG. 4) onto floor 84 of base 76, latch mechanism 56 is actuated. In particular, latch mechanism 56 is pivoted about pivot shaft 114 from the position shown in FIG. 7 to the position shown in FIG. 8. As body 120 is pivoted from the open position shown in FIG. 7 to the closed position shown in FIG. 8, wings 188 of retainer 126 bear against sidewalls 78 and 80 to twist torsion spring 184 until wings 188 pass catches 110. Once wings 188 have passed catches 110, torsion spring 184 resiliently biases wings 188 to a retaining position in which wings 188 are captured behind catches 110 to retain body 120 in the closed position.

As further illustrated by FIG. 9, during the pivotal movement of body 120 from the open position to the closed position, hook 144 is pivoted into latch engaging portion 89 of docking bay 54 while pusher 164 is brought into engagement with Y force receiving surface 210 and Z force receiving surface 212 of cartridge 24. As a result, spring 168 of bias mechanism 124 urges pusher 164 against surface 210 to urge print cartridge 24 in the negative Y-axis direction such that datums 204 and 206 are urged against datums 86 and 88, respectively, to locate print cartridge 24 along the Y-axis. Spring 142 urges structure 137 and pusher 164 against surface 212 to urge print cartridge 24 in the Z-axis direction until datums 202 are brought into engagement with and abut datums 87 of docking bay 54 as shown in FIG. 10.

To unload print cartridge 24, button portion 182 of retainer 126 is depressed in the negative Y-axis direction so as to pivot engaging portion 180 against the bias of spring 184 out of engagement with catches 110. After wings 188 have been lifted out of engagement with catches 110, spring 142 returns to its relaxed state, urging body 120 away from surface 212 of print cartridge 24. As a result, body 120 and latch mechanism 56 are urged towards the open position. In addition, gravity also assists in moving body 120 from the closed position to the open position shown in FIG. 7. Consequently, print cartridge 24 may be unloaded by the user employing a single hand and pressing down upon button portion 182 of retainer 126.

Overall, print cartridge support system 26 precisely and reliably positions print cartridge 24 opposite a print medium supported in a non-horizontal orientation. As a result, support system 26 enables the printing system in which it is employed to print upon the medium while the medium is in a non-horizontal orientation so as to reduce its “in-use” footprint. At the same time, latch mechanism 56 enables print cartridges 24 to be easily loaded and unloaded from docking bay 54 without requiring the user to use multiple hands.

Although docking bay 54 and latch mechanism 56 of print cartridge support system 26 are illustrated as providing several benefits when supporting a nozzle face of a print cartridge opposite a non-horizontally supported print medium, docking bay 54 and latch mechanism 56 may alternatively be employed in printing systems in which the print medium extends in a substantially horizontal plane during printing.

Although the present invention has been described with reference to example embodiments, workers skilled in the art will recognize that changes may be made in form and detail without departing from the spirit and scope of the invention. For example, although different example embodiments may have been described as including one or more features providing one or more benefits, it is contemplated that the described features may be interchanged with one another or alternatively be combined with one another in the described example embodiments or in other alternative embodiments. Because the technology of the present invention is relatively complex, not all changes in the technology are foreseeable. The present invention described with reference to the example embodiments and set forth in the following claims is manifestly intended to be as broad as possible. For example, unless specifically otherwise noted, the claims reciting a single particular element also encompass a plurality of such particular elements.

1. A print cartridge support system for locating a print cartridge in a printer, the system comprising:
a cartridge docking bay configured to removably receive the print cartridge; and
a latch mechanism including:
a body movably supported relative to the bay for movement between a closed position and an open position; and
a retainer movably coupled to the body to move between a retaining position in which the retainer releasably engages the bay when the body is in the closed position and a releasing position.

2. The system of claim 1 including a first catch coupled to the docking bay, wherein the retainer includes a second catch configured to releasably engage the first catch when the body is in the closed position and when the retainer is in the retaining position.

3. The system of claim 2, wherein the first catch is fixedly coupled to the docking bay.

4. The system of claim 1, wherein the retainer extends substantially perpendicular to the body when in the retaining position.

5. The system of claim 1 including a first bias mechanism coupled to the body and configured to urge the cartridge in a first direction when the body is in the closed position.

6. The system of claim 5, wherein the first bias mechanism urges the cartridge in a first direction which is substantially perpendicular to the body.

7. The system of claim 5, wherein the first bias mechanism urges the cartridge in a first direction which is substantially parallel to the body.

8. The system of claim 5 including a second bias mechanism coupled to the body and configured to urge the cartridge in a second direction when the body is in the closed position.

9. The system of claim 8, wherein the first direction and the second direction are perpendicular to one another.

10. The system of claim 1, wherein the cartridge includes a nozzle face and wherein the docking bay is configured to receive the cartridge with the nozzle face extending in a plane no greater than 22.5 degrees from vertical.

11. The system of claim 9, wherein the docking bay is configured to receive the cartridge with the nozzle face extending in a plane no greater than 15 degrees from vertical.

12. The system of claim 11, wherein the docking bay is configured to receive the cartridge with the nozzle face extending in a plane no greater than 5 degrees from vertical.

13. The system of claim 1, wherein the body extends in a non-horizontal plane when in the closed position.

14. The system of claim 1, wherein the retainer is resiliently biased towards the retaining position.

15. The system of claim 1, wherein the retainer is pivotally coupled to the body so as to pivot between the retaining position and the releasing position.

16. The system of claim 15, wherein the body is pivotally supported so as to pivot between the open position and the closed position.

17. The system of claim 14, wherein the retainer pivots about a pivot shaft.

18. The system of claim 1, wherein the retainer pivots about an axis relative to the body and wherein the retainer includes:
a bay engaging portion on a first side of the axis and a button portion on a second side of the axis, wherein depressment of the button portion disengages the engagement portion from the bay.

19. The system of claim 1, wherein the retaining portion extends substantially horizontal when the body is in the closed position and when the retainer is in the retaining position.

20. The system of claim 1, wherein the body is pivotally supported so as to pivot between the closed position and the open position.

21. The system of claim 20, wherein the body pivots from the closed position to the open position with assistance from gravity.

22. The system of claim 1 including a bias mechanism coupled to the body and configured to urge the cartridge in a first direction while the body is in the closed position and while the retainer is in the retaining position and to urge the body towards the open position when the retainer is in the releasing position.

23. The system of claim 1 including a bias mechanism coupled to the body and configured to urge the cartridge in a substantially horizontal direction while the body is in the closed position.

24. The system of claim 1 including:
a first member movably coupled to the body to move in a first substantially horizontal direction when the body is in the closed position; and
a second member movably coupled to the first member to move in a second non-horizontal direction when the body is in the closed position, wherein the first member is resiliently biased away from the body and wherein the second member is resiliently biased in the non-horizontal direction.

25. The system of claim 1, wherein the docking bay includes a floor configured to extend below a majority of the cartridge when the cartridge is received within the bay.

26. A printer comprising:
a print cartridge support system configured to locate a print cartridge proximate a print medium, the system including:
a cartridge docking bay configured to removably receive the print cartridge; and
a latch mechanism including:
a body movably supported relative to the bay for movement between a closed position and an open position; and
a retainer movably coupled to the body to move between a retaining position in which the retainer releasably engages the bay when the body is in the closed position and a releasing position.

27. The printer of claim 26 including a media supply, wherein the print cartridge has a nozzle face and wherein the media supply is configured to move the print medium in a non-horizontal direction opposite the nozzle face.

28. The printer of claim 27, wherein the media support is configured to move a medium in a first non-horizontal direction and in a second substantially opposite non-horizontal direction.

29. The printer of claim 26, wherein the support system is movably supported to scan across the print medium.

30. A printing system comprising:
a media supply configured to move a print medium;
a print cartridge; and
a cartridge support system locating the print cartridge proximate the print medium, the cartridge support system including:
a cartridge docking bay configured to removably receive the print cartridge; and
a latch mechanism including:
a body movably supported relative to the bay for movement between a closed position and an open position; and
a retainer movably coupled to the body to move between a retaining position in which the retainer releasably engages the bay when the body is in the closed position and a releasing position.

31. A print cartridge support system for locating a print cartridge having a nozzle face in a printer, the system comprising:
a print cartridge docking bay having a top opening through which the bay receives the print cartridge, wherein the bay is configured to support the print cartridge with the nozzle face in a plane no greater than 22.5 degrees from vertical; and
a latch mechanism configured to urge the nozzle face towards the print medium.

32. The system of claim 31, wherein the latch mechanism includes:
a body movably supported relative to the bay to move between a closed position and an open position; and
a retainer movably coupled to the body to move between a retaining position in which the retainer releasably retains the body in the closed position and a releasing position.

33. The system of claim 32, wherein the latch mechanism includes a bias mechanism coupled to the body and configured to urge the print cartridge in a first direction while the body is in the closed position and while the retainer is in the retaining position and to urge the body towards the open position when the retainer is in the released position.

34. The system of claim 32, wherein the retainer extends substantially perpendicular to the body when in the retaining position.

35. The system of claim 32 including a second bias mechanism coupled to the body and configured to urge the cartridge in a second direction when the body is in the closed position.

36. A print cartridge support system for supporting a print cartridge having a nozzle face proximate a medium, the system comprising:
means for supporting the cartridge with the nozzle face extending no greater than 22.5 degrees from non-horizontal; and
means for urging the nozzle face towards the print medium.

37. The system of claim 36, wherein the means for supporting locates the cartridge against movement along a first orthogonal axis and wherein the means for urging locates the cartridge along a second orthogonal axis.

38. The system of claim 37 including means for urging the cartridge to locate the cartridge along a third orthogonal axis.

39. A method for loading a print cartridge into a printer, the method comprising:
inserting the cartridge into a bay at an orientation so that a nozzle face of the cartridge extends in a plane no greater than 22.5 degrees from vertical; and
retaining the cartridge in the bay.

40. The method of claim 39, wherein the step of retaining includes:
moving a latch body from an open position permitting insertion of the cartridge into the bay to a closed position preventing removal of the cartridge from the bay; and
securing the body in the closed position.

41. The method of claim 40, wherein the step of securing includes moving a retainer coupled to the body from a releasing position to a retaining position in which the retainer is releasably secured to the bay to retain the body in the closed position.

42. The method of claim 41, wherein the step of moving the retainer from the releasing position to the retaining position comprises pivoting the retainer from the releasing position to the retaining position.

43. The method of claim 40, wherein the step of moving the latch body from the open position to the closed position comprises pivoting the latch body from the open position to the closed position.

44. The method of claim 39 including the step of urging the print cartridge in a first orthogonal direction against a first cartridge locating surface.

45. The method of claim 44 including urging the print cartridge in a second orthogonal direction against a second cartridge locating surface.
